(19) United States
(12) Patent Application Publication
(10) Pub. No.: US 2018/0024989 A1
(43) Pub. Date: Jan. 25, 2018

(54) AUTOMATED BUILDING AND SEQUENCING OF A STORYLINE AND SCENES, OR SECTIONS, INCLUDED THEREIN

(71) Applicant: International Business Machines Corporation, Armonk, NY (US)

(72) Inventors: Harish Bharti, Pune (IN); Sanjib Choudhury, Pune (IN); Kshitij K. Raval, Pune (IN); Rajesh K. Saxena, Pune (IN)

(21) Appl. No.: 15/213,867

(22) Filed: Jul. 19, 2016

(51) Int. Cl. G06F 17/27; G06F 17/30

(52) U.S. Cl. CPC G06F 17/2775; G06F 17/30958; G06F 17/279

(57) ABSTRACT

A method uses random walk traversal(s) (for example, Lévy's flight algorithm) of a story data graph to help select and/or order nodes for automated story writing purposes. Dialogue metadata (for example, inverted quotation marks) is added, to indicate natural language dialogue in nodes of the story data graph. A cyclic, non-directed story data graph is partitioned into non-cyclic tree(s) (also called tree logical data structures) using nodes and connections from the story data graph.

### BACKGROUND

The present invention relates generally to the field of automated story composition, and more particularly to machine logic for building and/or sequencing storyline sections.

The concept of using machine logic (that is, computer hardware and/or software) to write human understandable stories in natural language text is known. This concept is sometimes herein referred to as “automated story writing.” There is a large amount of “unstructured” content available on the internet, including social media websites and websites authored by human experts in various subject matter areas. This “unstructured” content refers to the fact that the content is designed to be understood by humans, rather than machines. This unstructured content includes natural language text, images, video and/or audio. It is also known that subject matter of unstructured content on the internet may be combined to provide, or at least partially provide, subject matter for automated story writing.

The use of random walk algorithms is known. As of Jun. 27, 2016, the Wikipedia entry for “random walk” reads as follows: “A random walk is a mathematical formalization of a path that consists of a succession of random steps. For example, the path traced by a molecule as it travels in a liquid or a gas, the search path of a foraging animal, the price of a fluctuating stock and the financial status of a gambler can all be modeled as random walks, although they may not be truly random in reality . . . . Random walks have been used in many fields: ecology, economics, psychology, computer science, physics, chemistry, and biology . . . . Often, random walks are assumed to be Markov chains or Markov processes, but other, more complicated walks are also of interest. Some random walks are on graphs, others on the line, in the plane, in higher dimensions, or even curved surfaces, while some random walks are on groups . . . . Specific cases or limits of random walks include the Lévy flight . . . .”

As of Jun. 27, 2016, the Wikipedia entry for “Lévy's flight” reads as follows: “A Lévy flight . . . is a random walk in which the step-lengths have a probability distribution that is heavy-tailed. When defined as a walk in a space of dimension greater than one, the steps made are in isotropic random directions. Later researchers have extended the use of the term “Lévy flight” to include cases where the random walk takes place on a discrete grid rather than on a continuous space . . . . A Lévy flight is a random walk in which the steps are defined in terms of the step-lengths, which have a certain probability distribution, with the directions of the steps being isotropic and random . . . .”

### SUMMARY

According to an aspect of the present invention, there is a method for composing an automated story that performs the following operations (not necessarily in the following order): (i) receiving a story data graph comprising a plurality of nodes including content and a plurality of connections among and between the nodes; (ii) selecting a starting node from the plurality of nodes; (iii) performing, using a content curator algorithm, a first random walk according to a first random walk algorithm, with the first random walk: (a) starting with the starting node, (b) traversing a plurality of first-random-walk-traversed nodes of the plurality of nodes, and (c) following connections of the plurality of connections of the story data graph on the first random walk; and (iv) outputting a first-random-walk-traversed data set that indicates an identity and order of traversal of the first-random-walk-traversed nodes to further stages of an automated story writing program.

According to a further aspect of the present invention, there is a computer program product for composing an automated story that performs the following operations (not necessarily in the following order): (i) receiving a story data graph comprising a plurality of nodes including content and a plurality of connections among and between the nodes; (ii) selecting a starting node from the plurality of nodes; (iii) performing, using a content curator algorithm, a first random walk according to a first random walk algorithm, with the first random walk: (a) starting with the starting node, (b) traversing a plurality of first-random-walk-traversed nodes of the plurality of nodes, and (c) following connections of the plurality of connections of the story data graph on the first random walk; and (iv) outputting a first-random-walk-traversed data set that indicates an identity and order of traversal of the first-random-walk-traversed nodes to further stages of an automated story writing program.

According to a further aspect of the present invention, there is a system for composing an automated story that performs the following operations (not necessarily in the following order): (i) receiving a story data graph comprising a plurality of nodes including content and a plurality of connections among and between the nodes; (ii) selecting a starting node from the plurality of nodes; (iii) performing, using a content curator algorithm, a first random walk according to a first random walk algorithm, with the first random walk: (a) starting with the starting node, (b) traversing a plurality of first-random-walk-traversed nodes of the plurality of nodes, and (c) following connections of the plurality of connections of the story data graph on the first random walk; and (iv) outputting a first-random-walk-traversed data set that indicates an identity and order of traversal of the first-random-walk-traversed nodes to further stages of an automated story writing program.

According to a further aspect of the present invention, there is a method for composing an automated story that performs the following operations (not necessarily in the following order): (i) receiving a story data graph comprising a plurality of nodes including content and a plurality of connections among and between the nodes; (ii) identifying, by machine logic, a plurality of dialogue portions in the content of the plurality of nodes, with each dialogue portion representing content that was presented as natural language dialogue at a network addressable site from which dialogue portion was collected; (iii) responsive to identification of each given dialogue portion, adding dialogue metadata identifying the dialogue portion to a node, of the plurality of nodes of the story data graph, corresponding to the given dialogue portion; and (iv) outputting the dialogue metadata of the plurality of nodes of the story data graph to further stages of an automated story writing program.

According to a further aspect of the present invention, there is a computer program product for composing an automated story that performs the following operations (not necessarily in the following order): (i) receiving a story data graph comprising a plurality of nodes including content and a plurality of connections among and between the nodes; (ii) identifying, by machine logic, a plurality of dialogue portions in the content of the plurality of nodes, with each dialogue portion representing content that was presented as natural language dialogue at a network addressable site from which dialogue portion was collected; (iii) responsive to identification of each given dialogue portion, adding dialogue metadata identifying the dialogue portion to a node, of the plurality of nodes of the story data graph, corresponding to the given dialogue portion; and (iv) outputting the dialogue metadata of the plurality of nodes of the story data graph to further stages of an automated story writing program.

According to a further aspect of the present invention, there is a system for composing an automated story that performs the following operations (not necessarily in the following order): (i) receiving a story data graph comprising a plurality of nodes including content and a plurality of connections among and between the nodes; (ii) identifying, by machine logic, a plurality of dialogue portions in the content of the plurality of nodes, with each dialogue portion representing content that was presented as natural language dialogue at a network addressable site from which dialogue portion was collected; (iii) responsive to identification of each given dialogue portion, adding dialogue metadata identifying the dialogue portion to a node, of the plurality of nodes of the story data graph, corresponding to the given dialogue portion; and (iv) outputting the dialogue metadata of the plurality of nodes of the story data graph to further stages of an automated story writing program.

According to a further aspect of the present invention, there is a method for composing an automated story that performs the following operations (not necessarily in the following order): (i) receiving a story data graph comprising a plurality of nodes including content and a plurality of connections among and between the nodes; (ii) selecting a root node from the plurality of nodes of the story data graph; (iii) partitioning, using machine logic, the graph to generate a tree data structure based on at least a portion of the story data graph, with the tree data structure: (a) having its root node correspond to the selected root node from the story data graph, (b) having a plurality of non-root nodes corresponding to at least some of the plurality of nodes of the story data graph, and (c) having the root and non-root nodes connected in a hierarchical manner based on the plurality of connections of the story data graph; and (iv) outputting the tree data structure to further stages of an automated story writing program.

According to a further aspect of the present invention, there is a computer program product for composing an automated story that performs the following operations (not necessarily in the following order): (i) receiving a story data graph comprising a plurality of nodes including content and a plurality of connections among and between the nodes; (ii) selecting a root node from the plurality of nodes of the story data graph; (iii) partitioning, using machine logic, the graph to generate a tree data structure based on at least a portion of the story data graph, with the tree data structure: (a) having its root node correspond to the selected root node from the story data graph, (b) having a plurality of non-root nodes corresponding to at least some of the plurality of nodes of the story data graph, and (c) having the root and non-root nodes connected in a hierarchical manner based on the plurality of connections of the story data graph; and (iv) outputting the tree data structure to further stages of an automated story writing program.

According to a further aspect of the present invention, there is a system for composing an automated story that performs the following operations (not necessarily in the following order): (i) receiving a story data graph comprising a plurality of nodes including content and a plurality of connections among and between the nodes; (ii) selecting a root node from the plurality of nodes of the story data graph; (iii) partitioning, using machine logic, the graph to generate a tree data structure based on at least a portion of the story data graph, with the tree data structure: (a) having its root node correspond to the selected root node from the story data graph, (b) having a plurality of non-root nodes corresponding to at least some of the plurality of nodes of the story data graph, and (c) having the root and non-root nodes connected in a hierarchical manner based on the plurality of connections of the story data graph; and (iv) outputting the tree data structure to further stages of an automated story writing program.

### BRIEF DESCRIPTION OF THE DRAWINGS

FIG. 1A is a block diagram of a first embodiment of a system according to the present invention;

FIG. 1B is a block diagram of a portion of the first embodiment system;

FIG. 2 is a flowchart showing a first embodiment of a method performed, at least in part, by the first embodiment system;

FIG. 3 is a block diagram showing a machine logic (for example, software) portion of the first embodiment system;

FIG. 4A is a block diagram showing a first view of a story data graph used by the first embodiment system in performing the first embodiment method;

FIG. 4B is a block diagram showing a second view of a story data graph used by the first embodiment system in performing the first embodiment method;

FIG. 5 is a scene/sentiment mapping table showing information that is helpful in understanding embodiments of the present invention;

FIG. 6 is a graph showing information that is generated by embodiments of the present invention; and

FIG. 7 is a graph showing information that is generated by embodiments of the present invention.

### DETAILED DESCRIPTION

Some embodiments of the present invention may: (i) use random walk traversal(s) (for example, Lévy's flight algorithm) of a story data graph to help select and/or order nodes for automated story writing purposes; (ii) add dialogue metadata (for example, inverted quotation marks) indicating natural language dialogue type content in nodes of the story data graph; and/or (iii) partition a cyclic, non-directed story data graph into non-cyclic tree(s) (also called tree logical data structures) using nodes and connections from the story data graph.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

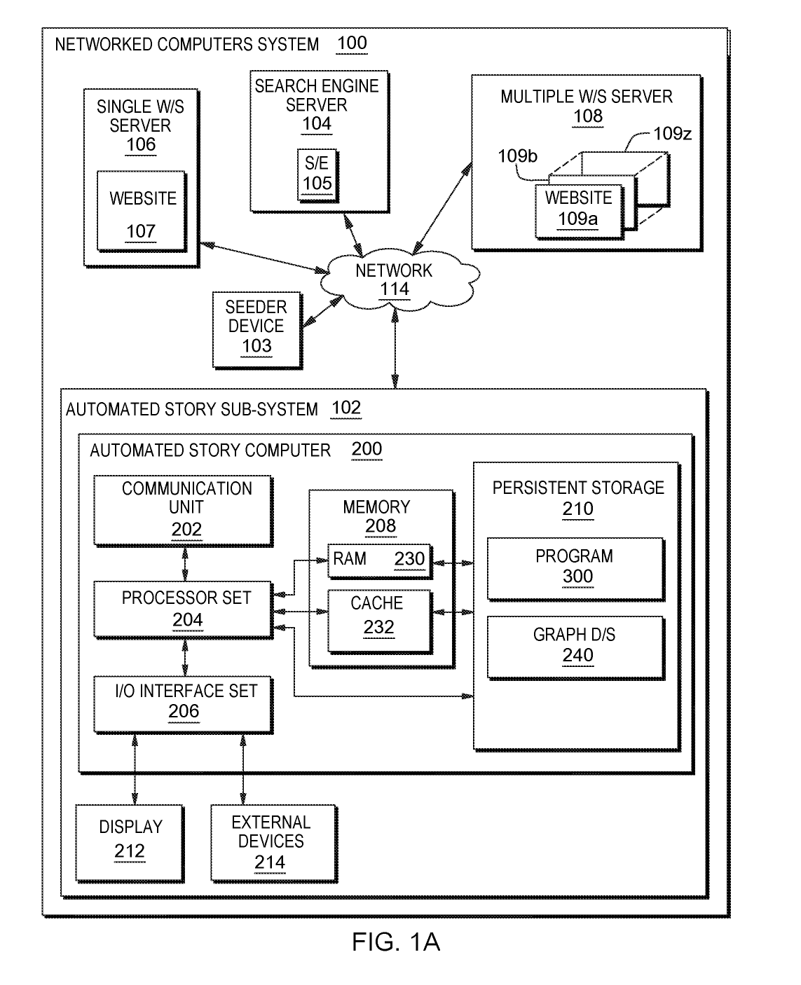

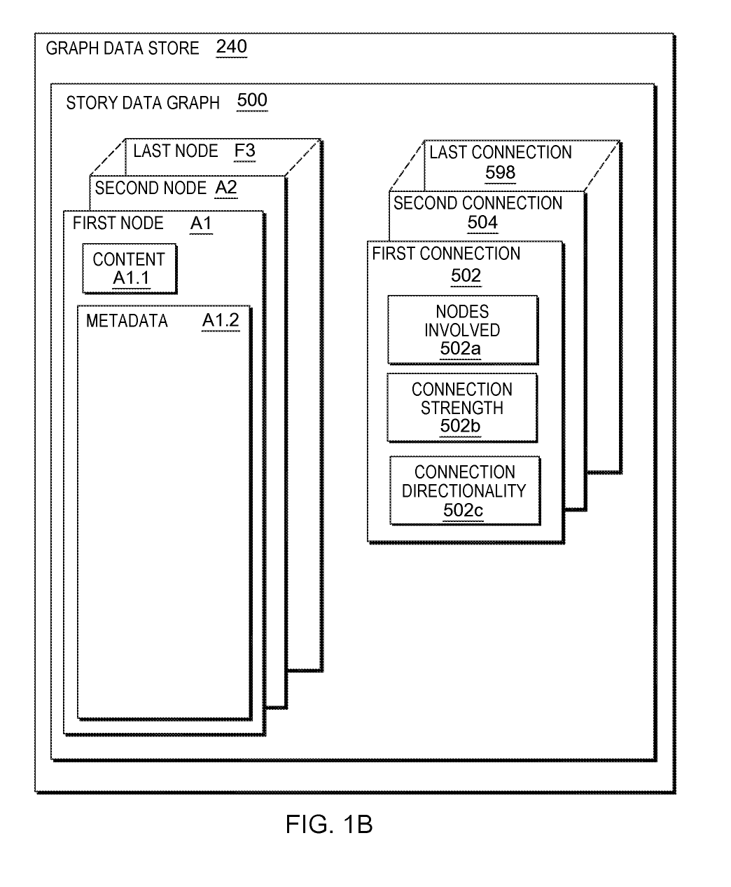

An embodiment of a possible hardware and software environment for software and/or methods according to the present invention will now be described in detail with reference to the Figures. FIG. 1A is a functional block diagram illustrating various portions of networked computers system 100, including: automated story sub-system 102; seeder device 103; search engine server 104; search engine 105; single workstation server 106; website 107; multiple workstation server 108; websites 109a through 109z; communication network 114; automated story computer 200; communication unit 202; processor set 204; input/output (I/O) interface set 206; memory device 208; persistent storage device 210; display device 212; external device set 214; random access memory (RAM) devices 230; cache memory device 232; graph data set 240; and program 300. FIG. 1B is a block diagram illustrating some contents of graph data set 240 (also sometimes referred to herein as graph data store 240), including: story data graph 500; first node A1; content A1.1; metadata A1.2; second node A2; last node F3; first connection 502; nodes involved 502a; connections strength 502b; connection directionality 502c; second connection 504; and last connection 598.

Automated story sub-system 102 is, in many respects, representative of the various computer sub-system(s) in the present invention. Accordingly, several portions of automated story sub-system 102 will now be discussed in the following paragraphs.

Automated story sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Automated story sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Automated story sub-system 102 is shown as a block diagram with many double arrows. These double arrows (no separate reference numerals) represent a communications fabric, which provides communications between various components of automated story sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for automated story sub-system 102; and/or (ii) devices external to automated story sub-system 102 may be able to provide memory for automated story sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to automated story sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with automated story computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

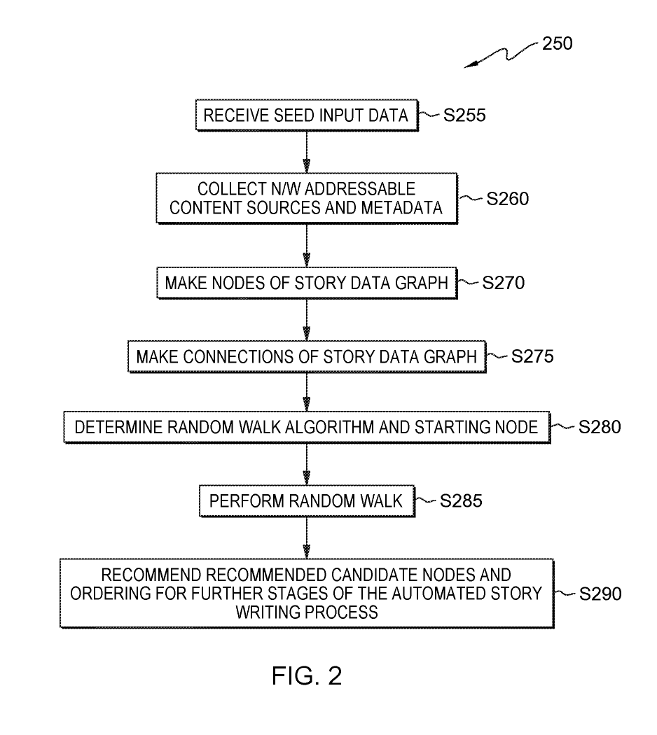

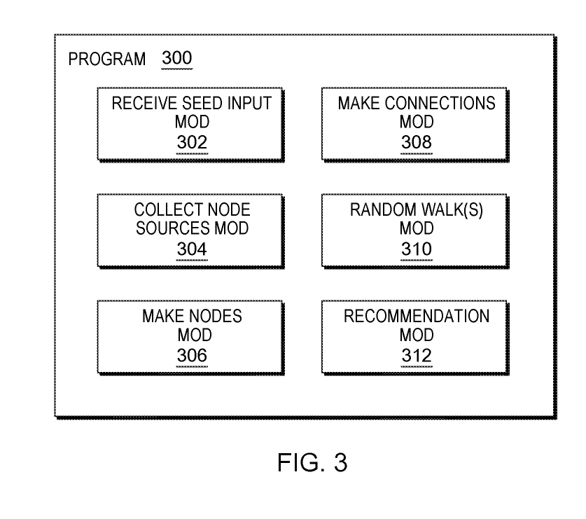

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where seed module (“mod”) 302 receives seed input data from seeder device 103 (for example, a word processing program running on a laptop computer) through communication network 114 (see FIG. 1A). In this embodiment, a human user supplies the story seed input data. Alternatively, the story seed input data could be supplied by machine logic. Generally speaking, the story seed input data includes information indicative, or descriptive, of how the automated story should turn out, but, of course, the story seed input data will be less elaborate and detailed than the finished story to be composed, in an automated fashion with substantially no human intervention (see definition, below, of “without substantial human intervention”) by program 300. More specifically, story seed input data may include one or more of the following types of seed information: topic, genre, context, key words or phrases, theme, mood, setting, time, place, emotional content, general outline.

Processing proceeds to operation S260, where collect node sources mod 304 collects content and metadata from various network addressable content sources (sometimes herein referred to as “web sites,” or, more simply “sites”). The sites will be used as sources of content to provide at least some of the subject matter for the writing of an automated story. In this example, the sites 107 and 109a to 109z are respectively collected, through communication network 114, from single website server 106 and multiple website server 108, as shown in FIG. 1A. Alternatively or additionally, other content sources may be used, such as archival, out-of-copyright literature brought to automated story sub-system 102 (see FIG. 1A) on physical media, rather than through communication network 114. In this example, and as will become relevant to this example later on, the metadata includes a data volume of the natural language text included in the content portion of each respective site.

In this example, data from eighteen (18) sites, (A1 to F3) is collected at operation S260 as follows: (A1) from an online encyclopedia type website, a definition “a pleasurable feeling deriving from emotional attraction” (natural language text data volume=10 units); (A2) from a how to site, an article on how to use a ruler (natural language text data volume=10 units); (A3) from a web site focused on novels of the “romance” genre, a list of some romance type novels and literary reviews thereof (natural language text data volume=90 units); (B1) from a song lyrics type web site, the lyrics to a popular “oldies” song called “Love Is A Much Enamored Thing” (natural language text data volume=50 units); (B2) a metric to English units of measure calculator site (natural language text data volume=13 units); (B3) from an online sports magazine, an article titled “Tennis player gets zero points” (the article including occurrences of the word “love” in the vernacular of scoring tennis games, natural language text data volume=99 units); (C1) from a web site purporting to provide “the best answer to any question”, an article stating that the profession of “doctor” is the least popular profession (natural language text data volume=9 units); (C2) a document outlining attributes and requirements for the position of “zoo keeper” (natural language text data volume=91 units); (C3) from a web site devoted to matching job seekers with employers, a listing of jobs in the field of “data analysis” (natural language text data volume=56 units); (D1) from a news web site, an article describing an elevated level of lead in a certain city's drinking water supply (natural language text data volume=12 units); (D2) an online encyclopedia-type website describing aspects of Ebola Virus Disease (natural language text data volume=87 units); (D3) from an online news website, an article focusing on a plan to improve primary school math education (natural language text data volume=20 units); (El) from a general news web site, an article describing health problems potentially causes by lead in drinking water (natural language text data volume=14 units); (E2) from a scientific journal, an article questioning whether health-related travel restrictions and travel bans can be an effective method of for containing an outbreak of Ebola infections (natural language text data volume=89 units); (E3) from a business news type web site, an article describing a correlation between math/science education in various nations and gross domestic product statistics for those nations (natural language text data volume=51 units); (F1) recipe written for making an apple pie (natural language text data volume=10 units); (F2) from a relationship advice type column, an article titled “Relationship Conflicts Settled Quickly” (natural language text data volume=90 units); and (F3) an article explaining that baked goods should have rectangular profiles for easier slicing and serving (natural language text data volume=50 units).

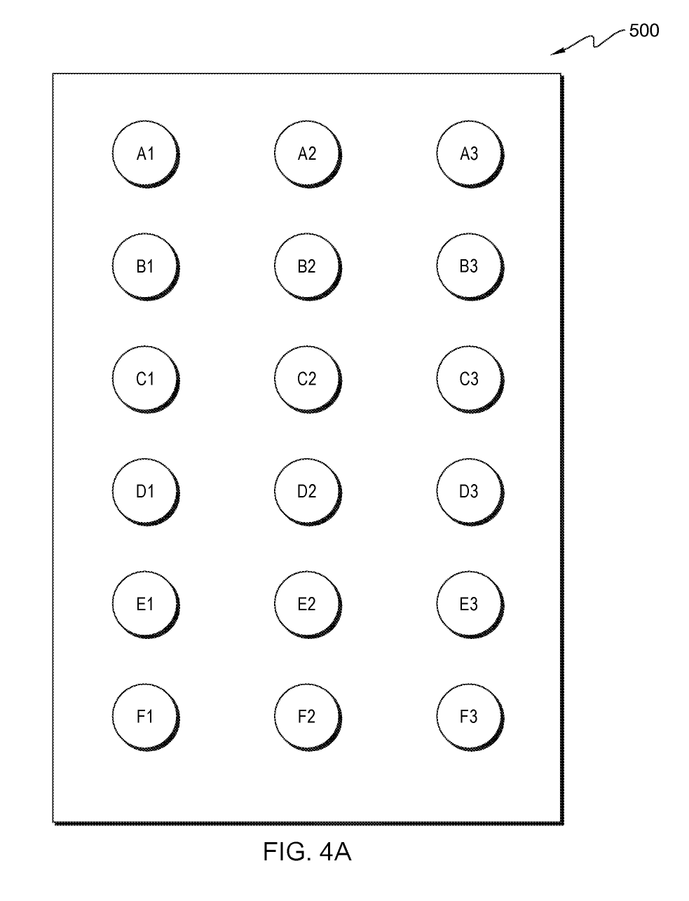

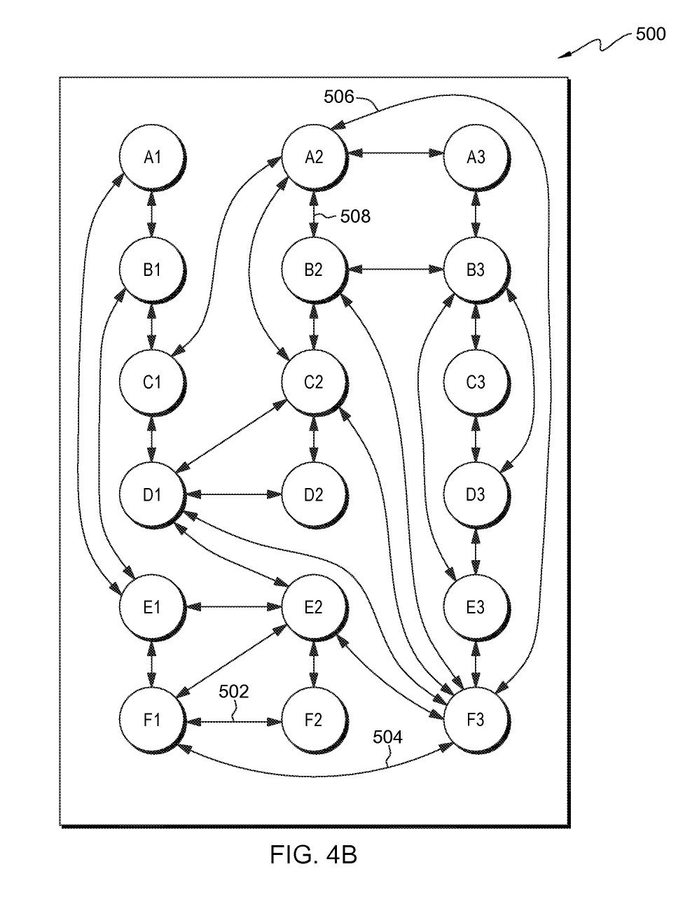

Processing proceeds to operation S270, where make nodes mod 306 uses the information collected at operation S260 to make node form data structures of story data graph 500 stored in graph data store 240 (see FIGS. 1A and 1B). More specifically, the content and metadata is communicated from the websites, through communication network 114, and into graph data store 240. FIG. 4A shows an abstract, human-understanding-oriented view of the eighteen (18) nodes, A1 to F3, made by operation S270. As shown in FIG. 1B, each node A1 to F3 includes: (i) a content portion, respectively A1.1 to F3.1 (not shown in the Figures); and (ii) a metadata portion, respectively A1.2 to F3.2 (not shown in the Figures). In this example, the metadata portions A1.2 to F3.2 include the natural language text data volume values recited above for each site (now node), as well as other metadata, such as contextual metadata and/or emotion, or sentiment, related metadata.

Processing proceeds to operation S275, where make connections mod 308 makes connections between the nodes of story data graph 500 based upon machine logic rules which use, as at least part of their respective inputs, content and/or metadata of the nodes A1 to F3. For example, nodes might be connected because their respective metadata indicates that they correspond to sites collected from the same server sub-system. As a further example, node might be connected because their respective content both include a common quotation, or saying. A complete discussion of how various embodiments may determine connections between nodes is beyond the scope of this document.

In this example, and as shown in FIG. 1B, each connection 502, 504 . . . 598 includes: (i) an identification of the nodes being connected (see nodes involved block 502a); (ii) a connection strength (or, in some embodiments “length”) (see connection strength block 502b); and (iii) connection directionality (see connection directionality block 502c). Alternatively, some embodiments may not include values for connection strength and/or directionality. FIG. 4B shows the connections made at operation S275 in the example currently under discussion. Many embodiments of the present invention will include many, many more nodes and many, many more connections in their story data graphs.

Processing proceeds to operation S280, where random walk(s) mod 310 determines which random walk algorithm to use and also selects a starting node for the random walk to be performed at operation S285 (to be discussed in detail, below). In this example, the selection of the random walk algorithm is trivial because there is only a single random walk algorithm coded into the machine logic of program 300. In this example, the starting node: (i) is chosen based on user input; and (ii) is selected to be node F2. Alternatively, the starting node could be selected by machine logic. In embodiments that perform multiple random walks, and then rank the results against each other, the starting node: (i) may be the same for each random walk; or (ii) may vary from one random walk to another.

Processing proceeds to operation S285, where a random walk is performed on story data graph 500 according to the algorithm of mod 310. In performing the random walk: (i) progress proceeds from a current node to a next node (which then becomes the current node in performing the subsequent step of the random walk); (ii) the determination of the next node needs to be at least somewhat random (although it may not completely random in the sense that some nodes may be more likely to be chosen than in others, as will be discussed below); and (iii) the identity and order of nodes in the random walk is stored as data for use in further stages of the automated story writing process.

In this particular example (but not necessarily under every random walk algorithm): (i) each step of the random walk proceeds along a connection of the story data graph; (ii) the total number of steps in the random walk is predetermined (specifically, four (4) steps and five (5) total nodes in this relatively simple example); (iii) nodes are ineligible to be revisited during the course of the random walk; and (iv) nodes are weighted more heavily (that is, more likely to be chosen for the path of the random walk) in proportion to the amount of text data volume they have. With respect to item (iii) of the foregoing list, it is noted that factoring text data volume into the step determinations of the random walk is not necessarily preferred, but merely presented in this example to give the reader some idea of the multitude of potential factors that can be considered in the random walk algorithm in various embodiments of the present invention (so long as there is some non-negligible degree of randomness inherent). In some embodiments, only some steps of the random walk may include random chance, while other steps are based more ineluctably on more determinative factors (such as chromatic polynomials representing emotion).

As best shown in FIG. 4B, in this example, the random walk of operation S285 proceeds through its three steps as follows: (i) from starting node F2 through connection 502 to node F1; (ii) from second node F2 through connection 504 to third node F3; (iii) from third node F3 through connection 506 to fourth node A2; and (iv) from fourth node A2 through connection 508 to fifth node B2. Accordingly, the nodes and their ordering under the random walk of this example can be represented as: F2>F1>F3>A2>B2.

The particular (not necessarily preferred, but hopefully instructive) random walk algorithm applied in operation S285 will now be discussed in more detail with reference to the third step from third node F3 to fourth node A2. As can be seen in FIG. 4B, third node F3 (that is, the current node when performing the third step) is connected, in data story graph 500, to seven (7) other nodes. However, under this particular random walk algorithm, nodes F1 and F2 are ineligible to be the next node designated by the third step because these nodes are already in the set of nodes for this random walk iteration. This leaves five nodes (specifically, A2, B2, C2, D1 and E2) as eligible to be chosen as the next node corresponding to the third step. In this example, each node is assigned a weighted relative probability according to the following formula: Pn=(1/5)*(data volume of text of node n)/(aggregate data volume of the five eligible nodes). Under this formula, the relatively probabilities for each node are as follows: (i) PA2=0.2*(10/215)=0.009; (ii) PB2=0.2*(13/215)=0.012; (iii) PC2=0.2*(91/215)=0.084; (iv) PD1=0.2*(10/215)=0.009; (v) PE2=0.2*(89/215)=0.083. A random number between 0.001 and 0.197 (that is, the aggregate weighted probability values for the five (5) eligible nodes) will be chosen. If the random number is: (i) between 0.001 and 0.009 then A2 will be chosen and the next step node; (ii) between 0.010 and 0.021 then node B2 will be chosen; (iii) between 0.022 and 0.105 then node C2 will be chosen; (iv) between 0.106 and 0.114 then D1 will be chosen; and (v) between 0.115 and 0.197 then node E2 will be chosen. In this example, mod 310 generates 0.003 as the random number, meaning that node A2, reached through connection 506 (see FIG. 4B), is chosen as the next step node from current node F3.

Although this relatively simple embodiment performs only a single iteration of a random walk based on a single random walk algorithm, alternatively other embodiments may: (i) perform multiple random walk iteration; (ii) rate the results of multiple random walk iterations relative to each other; (iii) use different random walk algorithms in different iterations; and/or (iv) use the same random walk algorithms in different iterations. Some other random walk algorithms (such as the isotropic and heavy-tailed type of algorithms known, collectively, as Lévy's flight) may be discussed.

Processing proceeds to operation S290, where recommendation mod 312 recommends candidate nodes and ordering, based on the random walk. Specifically, in this example, the traversed random walk nodes and ordering are as follows: F2>F1>F3>A2>B2.

Although the machine logic driving further stages of the automated story writing process will not be discussed here in detail, a sample story follows to help the reader appreciate the impact of the random walk (including the impact of its randomness) on the writing of an automated story.

ABEL AND BAKER MAKE A PIE: Abel and Baker had just finished settling a conflict over the relationship between the number pi and breadth and perimeter of a pie. (See node F2, described above.) Abel said that the talk of pie was causing hunger and that they should make a pie together using raisins for extra sweetness to counteract the natural tartness of the apples. (See node F1, described above.) Baker realized that that was a good idea, but they should make the pie square so that the apple pie would be easy to slice and share when their friends came over later to watch a cricket match. (See node F3, described above). After the apple pie with internal raisins was formed and cooled to slightly above ambient temperature, Abel used a tape measure to determine the breadth and perimeter of the apple pie. (See node A2, described above.) To Abel and Baker's mutual astonishment, they discovered that its perimeter was not pi times its breadth, but rather four (4) times its breadth. After a pause for thoughts, Baker reasoned that the pie pan was made in metric units, and metric pi must therefore be equal to 4.00000 in order to better afford the simplicity of calculation for which the metric system is famous. (See node B2, described above.) Later on Abel and Baker's friends came over, but they did not eat the pie because the cricket was not on the television, but, rather, had hopped up on the apple pie. Grody to the max, all present were so sure. THE END.

### III. Further Comments and/or Embodiments

Some embodiments of the present invention are directed to a part of automated story writing where a storyline is constructed from individual scenes. This part of automated story writing may be part of a larger method as follows: (i) content selection (content analysis from diverse sources based on desired context, qualitative linking and selection of content); (ii) bring wisely chosen emotions (identify different sentiments with available content, contextualize and further shortlist based on sentiments); and (iii) storyline is constructed from individual scenes (build storyline, sequencing of content, structure individual scene). It is noted that the foregoing three operations (i) to (iii), and the sub-operations within these operations may be performed in a way where the operations overlap in time, and/or where processing proceeds it a back-and-forth, or recursive, manner as between the operations and/or sub-operations.

One method according to the present inventions includes the following operations (not necessarily in the following order): (i) the outline of the story is constructed (to begin with there will be many possibilities of articles for a given combination of sentiments); (ii) a method to traverse through these articles and find the most relevant ones for the given scene is performed by Content Curator Algorithm, which performs the following sub-operations: (a) build the scenes as the vertices, (b) define various traverses through the graph, (c) using a traversing algorithm (for example, Lévy's algorithm) identifying the most important vertices of the graph, and (d) create options of traversals, rate them and expose them as the story line; (iii) sequence the scenes, including the following sub-operations: (a) the scenes are edited and created as a final story at this stage, unwanted content that does not have strong relevance with the genre is removed from the sequencing, and this is achieved by creating a directed graph using color attributes (such as color scale data) as edges, and (b) based on the metadata, the algorithm can also curate out the dialogues within the scenes, these are given by the nodes that have been culled out as microblog feeds, social media site comments or any personal dictat present in the results, the rules can be applied at this stage to wrap these nodes in inverted quotes to distinguish them from standard quotation marks, which are often used to punctuate “dialogues” present in the graph; and (iv) structure individual scenes, including the following sub-operations: (a) each screen is further enhanced with emotions/sentiments that become the moot point of developing the scene structure, author can ensure that all relevant sentiments are a part of the scene, (b) enhance a given Scene of Graph , partition the graph at the node such that there is obtained a tree originating from this scene, and then look at the colors that have been provided to the given node and color tree accordingly, and (c) the content curator algorithm can be called to provide the additional data point for the given scene.

Some embodiments may involve an application of graph theory to development of media storylines with the edges showing the emotions in different colors denoting the strengths, with the story threads coming from different sources. Some embodiments lay out the problem space which is automated plot development for the movies area and/or lay out the solution and the computation behind selection of the line of the plot. Some embodiments may involve the idea of using nodes to represent different story angles based on multiple sources and linking of the nodes by edges that represent emotions. As the emotions shown get repeated between different stories in the sources, the coloring of the edges becomes stronger in a color with different colors representing different emotions. Selecting the stronger plot line is enabled by the calculations that facilitate an automatic story plot creation using software.

The operation of building a story line may include the following features, operations, characteristics and/or advantages: (i) the outline of the story is constructed; (ii) although broadly the sequence of events is known but it is not built into the story line at this stage; (iii) build the scenes as the vertices; (iv) define various traverses through the graph; (v) using traversing algorithm (Lévy's algorithm) identification of the most important vertices of the graph; (vi) create options of traversals, rate them and expose them as the story line; and/or (vii) output types may include walks, path, circuits and/or Lévy's walk adoption.

The operation of sequence the scenes may include the following features, operations, characteristics and/or advantages: (i) the scenes are edited and created as a final story at this stage; (ii) unwanted content that does not have strong relevance with the genre is removed from the sequencing; (iii) sort the scenes based on the contextual weightages; (iv) count and enumerate the scenes using counting methodologies; and/or (v) output types may include range-bound sorting and/or Polya's counting.

The operation of structuring individual scenes may include the following features, operations, characteristics and/or advantages: (i) each screen is further articulated as a series of scene-sequel basis; (ii) emotions/sentiments are appropriately considered by machine logic based rules as the automated story software develops scene structure (for example, within scenes of an automated story, between scenes of an automated story); (iii) author ensures that all relevant sentiments are a part of the scene; (iv) for each vertex which has been identified as a scene in the sequence, include the sub-components on the logic that they cover the most pertinent colors imparted to the vertex under consideration; and/or (v) output types may include cut-sets and/or separable graphs.

FIRST OPERATION: Building a story line (traversal logic) will be discussed in the following paragraphs.

An outline of the story is constructed. Although the broad concept of the story is known, it is not built into the story line at this stage. Using sentiments as colors, the content is partitioned into k regions.

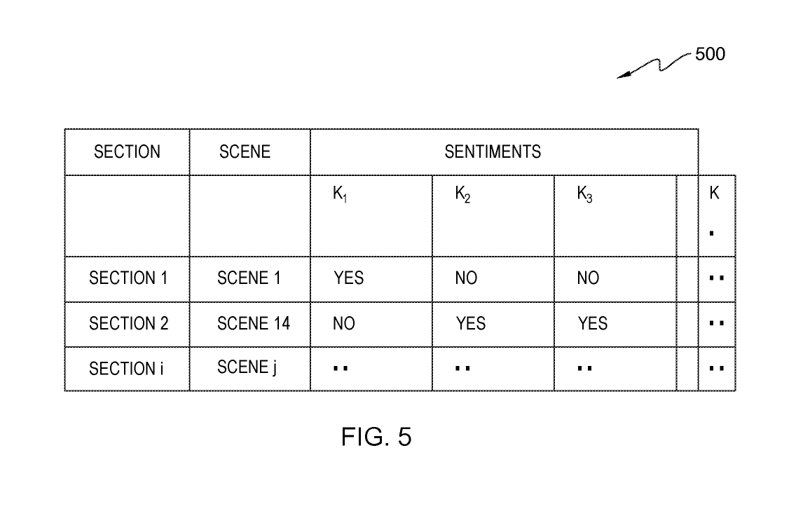

As summarized in scene/sentiment mapping table 500 of FIG. 5, given the analysis so far, the relevant data has been pulled by the author and has been further sectioned into various scenes. To adopt the content to, for example, a classic three-act structure, the author performs section-scene-k mapping such that the combination of Kₙ is unique for each scene.

Typically, there are many possible articles based on a given combination of sentiments K. Some embodiments of the present invention provide a method to traverse through these articles, to find the most relevant ones for a given scene, as given by the following content curator algorithm: (i) start with scene 1; (ii) create a fusion of the sub-graphs for which Kₘ has been set positive; (iii) find the degree sequence of the vertex in the new sub-graph; (iv) choose the highest degree vertex; (v) store the vertex as a new node in articleGraph (A_{di}); (vi) find the next highest vertex which is closest to this vertex; (vii) continue until the vertex degree is greater than k; (viii) move to next scene; and (ix) stop when the scenes are completed.

The foregoing content curator algorithm provides the relevant vertices to the author according to the scene sequence that has been established by the author.

SECOND OPERATION: Digraph, sorting and enumeration will be discussed in the following paragraphs.

The scenes are edited and created as a final story at this stage. Unwanted content that does not have strong relevance with the genre is removed from the sequencing.

The scenes are saved as new vertices in articleGraph (A_{di}) and the color-attributes connect them as edges. ArticleGraph (A_{di}) is directed, and therefore is a digraph. Equation 1 follows:

$${A}_{di} ( G ) ) = [ \begin{matrix}{a}_{11} & {a}_{12} & {a}_{13} & … & {a}_{1 n} \\ {a}_{21} & {a}_{22} & {a}_{23} & … & {a}_{2 n} \\ & & … & & \\ & & … & & \\ {a}_{m 1} & {a}_{m 2} & {a}_{m 3} & … & {a}_{mn}\end{matrix} ]$$

$$Where , \\ {a}_{ij} = \{ \begin{matrix}1 & if the {j}^{th} edge is incident out of {i}^{th} vertex \\ - 1 & if the {j}^{th} edge is incident into {i}^{th} vertex \\ 1 & if the {j}^{th} edge is not incident on {i}^{th} vertex\end{matrix}$$

It can be seen that now each scene has become a vertex and there is a clear understanding of how these scenes are connected with each other by using the directed graphs.

The quality index (Q) of A_{di}(G) is derived using the mathematics and logic, as set forth below.

$$Q = \frac{Rank of A ( G )}{Connectivity parity} = \frac{m - 1}{B}$$

A quality index Q that is close to 0 indicates poor quality data. If quality index Q is of a (pre-determined) acceptable level, then graph fitment is checked as follows: If rank of A_{di}(G)>K×number of scenes, then content curator algorithm is called again with vertex degree>(k−y), where y is set by the author to backtrack the acceptable graph rank.

Note that not only can the scenes now be sequenced, but based on the metadata, the algorithm also curates out the dialogues within the scenes. The dialogues are given by the nodes that have been culled out as, for example, social media feeds, comments or personal data that has been found in the results. Rules can be applied at this stage to wrap these nodes in inverted quotes to distinguish them from quotation marks used as natural language punctuation in the graph. Using the foregoing method, the scenes are edited to an acceptable range of graph span without losing quality index.

Separation and cut-sets will now be discussed. Each screen is further enhanced with emotions and/or sentiments that become the moot point of developing the scene structure. The author ensures that all relevant sentiments are a part of the scene. To enhance a scene Aₘ of Graph G, we have to partition the graph at the node Aₘ such that we get a tree originating from Aₘ, called G_{Am}. G_{Am} is colored according to the colors that have been provided to node Aₘ. The content curator algorithm is called to provide additional data point for the vertex Aₘ.

Some embodiments of the present invention may include one, or more, of the following features, characteristics and/or advantages: (i) sequences a story based on desired emotions in the story line; (ii) uses Lévy's algorithm to perform a robust and sophisticated traversing, to identify the most important vertices of the graph and to sequence the story based on content and the desired sequence of sentiments (content curator algorithm); and (iii) objective context that can be used as metadata to cull out the relevant discussions in the social media.

The outline of a story is initially constructed, having many possible articles for a given combination of sentiments. Some embodiments of the present invention traverse through these articles and find the most relevant ones for a given scene. This is achieved using content curator algorithm which: (i) builds scenes as the vertices of the graph; (ii) defines various traverses through the graph; (iii) uses Lévy's algorithm to traverse the graph, to identify the most important vertices of the graph; and/or (iv) creates options of traversals, rates the option(s) and exposes them as the story line.

The sequencing of the scenes will now be discussed. In some embodiments of the present invention, scenes are sequenced. The scenes are edited and created as a final story at this stage. Unwanted content that does not have strong relevance with the genre is removed from the sequencing. This is achieved by creating a directed graph using color attributes as edges. Based on the metadata, the content curator algorithm curates out dialogues within the scenes. Dialogues are given by the nodes that have been culled out as, for example, social media feeds, comments, posts, etc. found in the results. Rules are applied at this stage to wrap these “dialogue” nodes in inverted quotes to distinguish them as “dialogues” heard in the graph.

Structuring of the individual scenes will now be discussed. In some embodiments of the present invention, individual scenes are structured as follows: (i) each scene is further enhanced with emotions/sentiments that become the moot point of developing the scene structure, the author ensures that all relevant sentiments are included in the scene; (ii) to enhance a given scene of the graph, the graph is partitioned at the node (representing the scene) such that a tree (for example a type of tree graph characterized as a hierarchy of nodes) originates from the scene, the tree is colored based on colors that have been provided to the given node; and (iii) the content curator algorithm is called to provide the additional data point(s) for the given scene.

Some embodiments of the present invention may include one, or more, of the following features, characteristics and/or advantages: (i) applies to a large volume of content spread across different locations and repositories (for example, on the internet); (ii) uses Lévy's algorithm to address the issue of handling a large volume of content spread across different locations and repositories; (iii) content curator algorithm recursively identifies and organizes scenes within a story line, based on the rank and connection parity of the graph; (iv) based on metadata, content curator algorithm curates out dialogues within the scenes; (v) able to process unstructured content from diverse sources on, for example, the internet, using content curator algorithm along with Lévy's model; (vi) sequencing is based on content ordering as well as desired sequence of sentiments; (vii) has objective context that is used as metadata to cull out the relevant discussions in the social media; (viii) provides a mechanism to achieve a balance between quality content and desired emotions; and/or (ix) has elements to address desired sentiments.

Some embodiments of the present invention may include one, or more, of the following features, characteristics and/or advantages: (i) creates a graph where information from different sources is represented as nodes on a specific topic or context; (ii) edges between the nodes describe the relationship between the nodes, with reference to the context, so that different aspects to creating a story for the entertainment industry can be catered to; (iii) articles are stored as nodes and the metadata, backlinks, and context connects the nodes (connections are called edges); (iv) produces a graph database (graphDB) as a repository of all the articles or research elements that have been mined, and the articles are connected by the backlinks or any other contextual field(s) (such as date, time, geography, site, search keywords, etc.) that the author specifies (these contextual settings are parameterized and can be changed by the author); (v) the vector of a graph gives an understanding of the relevant linkages a given article (node) has with other articles (nodes) in the search results (graphDB) (the degree of the graph represents how strongly a given article is linked to other articles, such that a higher degree of graph indicates that the articles are very relevant and meet maximum search criteria); (vi) content shortlisting, and qualitative linking and ranking of nodes (ranking of graph and connectivity parity), means that all related content is available to be used for story writing; (vii) the rank of a graph is the maximum number of connections a single node can have in a simple graph (signifies maximum linkages that an article can have in a given result and helps to determine the quality of the findings, given that all findings have been organized as a graph); (viii) connectivity parity indicates the number of distinct paths that connect 2 nodes in the graph (connectivity parity indicates the traversals that are available to and from a given node, and traversals indicate the number of times a given node is used to move to the next node, and thus an importance or relevance metric of the node in the search result, where a node with high traversal becomes a significant spot (node) in the graph; and/or (ix) when sequencing unstructured data, both the traversals and rank are evaluated, and a pivotal node becomes the core construct of the subject.

In some embodiments of the present invention, the process used to sequence a story line starts with the strongest node, by identifying strongest linkages, then the next stronger node and so on. Strength is indicated by the color attributes (density of color as well as attributes connects these nodes). In this fashion, all nodes are sorted. At this final stage unwanted scenes are again removed by again evaluating quality in sequence context (quality of content may have been good but in a sequence context, quality is evaluated again). Finally we apply Separation & Cut Sets to further enhance story content for given scenes.

Some embodiments of the present invention perform sequencing based on desired emotions in the story line, to generate a story which is appealing to an audience. Lévy's algorithm is used to provide a robust and sophisticated traversing, to identify the most important vertices of the graph. The content curator algorithm performs the sequencing based on content as well as the desired sequence of sentiments (emotions). Objective context is used as metadata to cull out (identify) the relevant discussions (dialogue) in the social media.

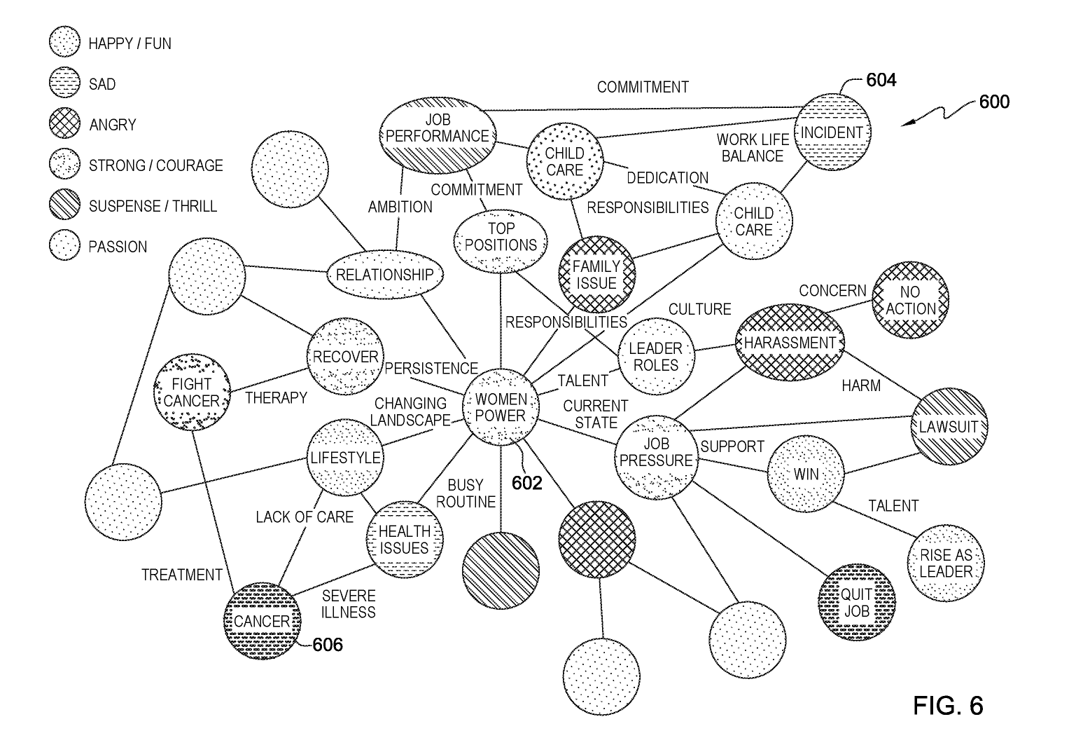

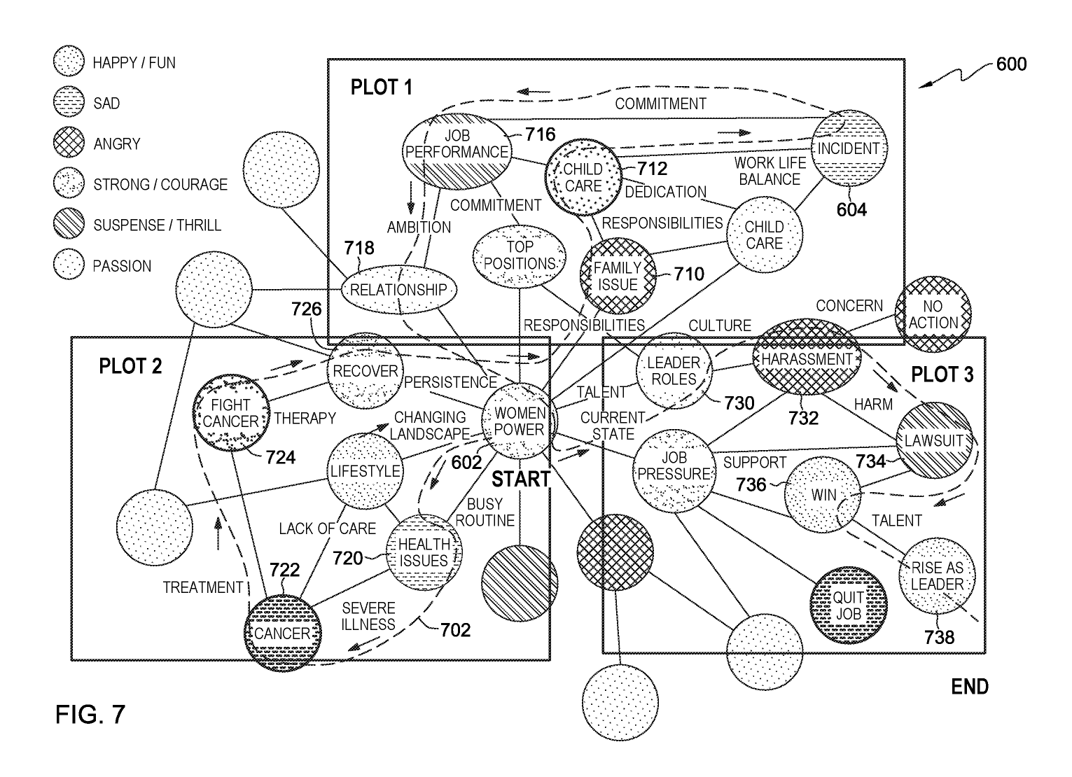

An example embodiment of the present invention will now be discussed with reference to FIGS. 6 and 7. This embodiment takes as input, graph 600 of FIG. 6, and data underlying the graph. Graph 600 represents: (i) shortlisted content; (ii) emotions associated with nodes of the graph; and (iii) intensity of the emotions.

The graph includes the following characteristics: (i) identifies the maximum and minimum color (chromatic) polynomials required to adequately cover the graph; (ii) maps the sentiments (emotions) identified with individual chromatic polynomials; (iii) colors the nodes according to the chromatic polynomials derived in item (ii) above; and/or (iv) identifies a minimal set to cover all vertices or edges of the graph.

An author can use the input information (graph and underlying data) as input for story writing based on the author's choice of emotions and emotional intensities, along with linkages of content already defined in graph 600. (Note, graph 600 is a small fictitious example but in practice, the graph would generally include a huge amount of shortlisted content.) Based on the author's choice of emotions and emotional intensities, content is selected or discarded.

In this embodiment, women power node 602 is associated with an emotion of courage and strength, at 80 percent intensity. A sample of extracted content includes: “Shree has achieved, in just 8 years, the position of account executive, a milestone that is generally achieved after 15 years of experience. She has been awarded with Best of Organization award for two consecutive years, for her contribution on troubled information technology projects . . . .”

Incident node 604, is associated with an emotion of sadness, at 60 percent intensity. A sample of extracted content represented by node 604 includes: “Rick is completely devastated, knowing he will have to be on bed rest for several weeks with no access to friends or outdoor games, and staying alone at home . . . .”

Cancer node 606, is associated with an emotion of sadness, at 80 percent intensity. A sample of extracted content represented by node 606 includes: “Finally, Shree makes some time to diagnose health issues that she has been facing for long time. Results of the diagnosis are shocking!! . . . .”

As shown in FIG. 7, Lévy's algorithm is applied to yield a most effective and appealing traverse 702, of graph 600. Traverse 702 identifies a sequence that ensures a correct flow of emotions, picks high intensity emotions mostly, but if in continuation, emotions with different intensities.

Each flow back to central construct is considered a plot. The author can provide preferences on desired emotions. For example: (i) plot 1 includes nodes 710, 712, 604, 716, and 718; plot 2 includes nodes 602, 720, 722, 724, and 726; and (iii) plot 3 includes nodes 730, 732, 734, 736, and 738.

An output from this embodiment includes a sequenced, shortlisted content for story writing. For example, plot 1 brings in emotions of courage, sadness and compassion as follows:

Content represented by women power node 602: “Globalization is also driving active participation from women. Women with exceptional leadership skills are rising to positions that were not thought possible a decade ago. Shree is one such woman, a very ambitious and talented software consultant. She is passionate for what she does on the job.”

Content represented by family issues node 710: “Family issues keep disturbing her on the job as she does not receive required support at home. It becomes very difficult for her to understand the priorities.”

Content represented by incident node 604: “One day, Shree's 7 year old son Rick meets with an accident in the day care facility and factures his leg. In spite of tremendous pressure at her job, her love for Rick takes priority. She takes a one week vacation to provide care and moral support to her son. However one week was not sufficient time. But if she takes a longer vacation, she will have to give away an exciting project she is handling for a client, the world's largest retail company. She seeks support from her spouse Jay, but their relationship is not very strong and it does not work out well—Jay has his own priorities and job role to keep him busy even during this time.

“Shree starts working from home. Her distraction from work is reflected in most of the calls she takes for her client. Within a week she gets a soft warning from her manager that the company may start losing business if she does not take her work more seriously. However even in this tough situation, she provides a compassionate environment to Rick, spends quality time with him and serves him some his favorite dishes. In another week's time Rick is able to walk with support and Shree gets good help from day care and her colleague Raj during this time. This incident makes her think seriously of her relationship with spouse Jay.”

Content represented by relationship node 718: “Shree finds spending time with Raj very comforting and relaxing. She starts wondering about how Raj would be as a spouse in real life? Shree has no idea at this time, as she does not know Raj outside the office environment. Her mind is in turmoil. But soon, her job priorities pull her full attention back to work.”

Plot 2 brings in emotions of courage, sadness, and adventure as will be discussed in the following paragraph(s).

Content represented by women power node 602—“As Shree tries to recover on the job, she puts in long hours in the office and still manages to spend some time with Rick every day. Her commitment to the job and exceptional performance brings additional business from the client—followed by her promotion to the position of Client Executive. This position is an important milestone Shree has been looking forward to. But her dream is to become Vice President for Retail Industry in her organization. She is determined to achieve her goal before she gets into a new relationship.”

Content represented by health issues node 720: “Shree's hectic schedule and little support at home takes a toll on her health. Her lifestyle, for a long period, has been very much of a workaholic, with too much fast food and too little exercise.”

Content represented by cancer node 722: “One day Shree is shocked to discover that she is suffering from cancer and it is already progressed to an advanced stage. Completely upset, she tries to look for somebody to cry with—as it would be tough for Rick. She chooses Jay to share this moment.”

Content represented by fight cancer node 724: “Jay knows Shree very well and provides all kinds of support to her during this tough time. He performs research on all the cases of similar cancers that have been treated successfully. He presents a very convincing plan to Shree with sufficient facts on this disease and the treatments available. This brings a new life and courage into Shree and she starts believing she can deal with this situation strongly.”

“Both Jay and Shree choose a well-known cancer center for treatment where she undergoes specialized testing for further diagnosis. A combination of surgery, and radiation therapy helps her recover from the chronic stage. Her relationship to Jay reaches to a whole new dimension during this period.”

Content represented by recover node 726: “Shree again has to play catch up at the office to fulfill her dreams in her professional life, before she commits to furthering her long term relationship with Jay.”

Plot 3 brings in emotions of passion, struggle, joy and strength.

Content represented by leadership role node 730: “In her eagerness to rapidly achieve her professional milestone Shree gets into the trap of one of her managers who continuously requests favors which are not fair in exchange for helping her achieve her professional milestone. Shree has been out of her job for quite some time and has lost most of her strong support connections. However, she decides to confront her manager in this situation. After her cancer episode, and now this kind of treatment from the boss, Shree was in a delicate frame of mind. She never would have expected such things to happen to her, especially not coming from someone with whom she had worked for years and trusted as a friend, philosopher and guide.”

Content represented by node 734: “She again gets help from Jay and takes legal action. She is quoted as one of the boldest women, for speaking out in this situation—and becomes an inspiration to many.”

Content represented by win node 736: “Shree's legal action proceeds in her favor. She starts getting more attention at work because of her history of success and recent demonstration of strong character as she becomes a popular woman icon at work.”

Content represented by rise as leader node 738: “Shree is given greater responsibilities that lead her way to become Vice President of Retail Industry.

Some embodiments of the present invention may include one, or more, of the following characteristics, operations, features and/or embodiments: (i) assumes that the variables are interdependent; (ii) does not expect set number of variables; (iii) gives flexibility to modify the number of variables for different iterations; (iv) accounts for interrelationships between variables; (v) does not apply distribution model to singletons; (vi) accounts for decisions to be uncertain; (vii) self-learns over iterations; (viii) allows past evidences to be attached; (ix) allows for the variables to change their relationships over different iterations; (x) focuses primarily on available multimedia; (xi) a structured approach for creating, from mining data available from social media, Internet and other sources, a cohesive story with a desired set of emotions; (xii) showcases comprehensive analysis and mathematical model justification as discussed above; (xiii) can be applied to create a story for a movie or a book which needs to bring out a cohesive story along with desired set of emotions; (xiv) a method for generating a story itself; (xv) creation of a more complete story from huge range of sources with unrelated content, which story provides a rich experience to audience which is mixed with desired set of emotions and messages; (xvi) sequencing a story line starting with a strongest node by identifying strongest linkages, then next stronger and so on; (xvii) strength depends on color attributes (density of color as well as attributes connects these nodes)—in this way all nodes are sorted; (xviii) at a final stage unwanted scenes are again removed by again evaluating Quality in sequence context (quality of content may have been good but in sequence context its quality is evaluated again); and (xix) application of separation and cut sets to further enhance story content for given scenes.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

“Nodes including content”: the content may be stored in a story data graph in the node data structure, itself, along with any other data of the node (for example, data identifying the node, contextual metadata, emotion metadata), or the node may contain a link to the content which is stored remote from the rest of the node; “content” may take the form of text, audio, video, still images, etc.

1. A computer-implemented method for composing an automated story, the computer-implemented method comprising:
receiving a story data graph comprising a plurality of nodes including content and a plurality of connections among and between the nodes;
selecting a starting node from the plurality of nodes;
performing, using a content curator algorithm, a first random walk according to a first random walk algorithm, with the first random walk: (i) starting with the starting node, (ii) traversing a plurality of first-random-walk-traversed nodes of the plurality of nodes, and (iii) following connections of the plurality of connections of the story data graph on the first random walk; and
outputting a first-random-walk-traversed data set that indicates an identity and order of traversal of the first-random-walk-traversed nodes to further stages of an automated story writing program.

2. The computer-implemented method of claim 1 further comprising:
receiving raw content and associated metadata; and
constructing the story data by forming the plurality of nodes and the plurality of connections as data structures, with the nodes and connections being based, at least in part, upon the raw content and associated metadata.

3. The computer-implemented method of claim 1 further comprising:
writing, by machine logic and based, at least in part, upon the first-random-walk-traversed data set, an automated story using content from at least some of the first-random-walk-traversed nodes at least partially in the order in which the first-random-walk-nodes were traversed on the first random walk.

4. The computer-implemented method of claim 1 wherein the first random walk algorithm is isotropic.

5. The computer-implemented method of claim 1 wherein the first random walk algorithm is characterized by a probability distribution that is heavy tailed.

6. The computer-implemented method of claim 1 wherein the first random walk algorithm is a Lévy's algorithm type of random walk algorithm.

7. The computer-implemented method of claim 1 further comprising:
repeatedly performing, using the content curator algorithm, a plurality of random walks to respectively generate a plurality of traversed node sets;
ranking the traversed node sets to obtain a preferred-traversed-node data set indicative of an identity and order of traversal of a highest ranked traversed node data set of the plurality of traversed node data sets; and
outputting the preferred-traversed-node data set to further stages of an automated story writing program.

8. The computer-implemented method of claim 7 further comprising:
writing, by machine logic and based, at least in part, upon the preferred-traversed-node data set, an automated story using content from at least some nodes of the preferred-traversed-node data set at least partially in the order indicated by the first preferred-node data set.

9-20. (canceled)
